(19) United States
(12) Patent Application Publication
(10) Pub. No.: US 2018/0351618 A1
(43) Pub. Date: Dec. 6, 2018

(54) USER EQUIPMENT AND OPERATION METHOD THEREOF, NETWORK DEVICE AND OPERATION METHOD THEREOF

(71) Applicant: INDUSTRIAL TECHNOLOGY RESEARCH INSTITUTE, Hsinchu (TW)

(72) Inventors: Chung-Lien HO, Taoyuan City (TW); Ren-Jr CHEN, Hsinchu City (TW); Zan-Yu CHEN, Taoyuan City (TW); Wen-Chiang CHEN, Hsinchu City (TW)

(21) Appl. No.: 15/839,041

(22) Filed: Dec. 12, 2017

Related U.S. Application Data
(60) Provisional application No. 62/516,081, filed on Jun. 6, 2017.

(30) Foreign Application Priority Data
Aug. 17, 2017 (TW) 106127912

(51) Int. Cl. H04B 7/06; H04B 7/0408

(52) U.S. Cl. CPC H04B 7/0608; H04W 88/02; H04B 7/0408; H04B 7/0632

(57) ABSTRACT

A user equipment includes: an antenna array for receiving a plurality of wireless signals from a plurality of beams; and a processing unit, coupled to the antenna array, the processing unit being configured to measure a plurality of wireless signal quality of the wireless signals to determine a target wireless signal quality among the plurality of wireless signal quality and the processing unit being configured to select, among the sectors, a beam emitting the target wireless signal quality as a preferred sector beam. The processing unit controls the antenna array to send to a current service sector beam of the beams a preferred sector beam transmission time index and a beam scan sequence ID corresponding to the target wireless signal quality.

### CROSS-REFERENCE TO RELATED ART

This application claims the benefit of U.S. provisional application Ser. No. 62/516,081, filed on Jun. 6, 2017, and the benefit of Taiwan application Serial No. 106127912, filed on Aug. 17, 2017, the subject matters of which are incorporated herein by references.

### TECHNICAL FIELD

The disclosure relates in general to a user equipment and an operation method thereof, and a network and an operation method thereof.

### BACKGROUND

Smart phones having wireless communication function become popular in people life. As for wireless communication or mobile communication, people may suffer from blockage and mobile terminal mobility when people use smart phones.

“Blockage” refers to that wireless signals from the base station may be blocked by the buildings nearby the user equipment or the mobile terminal, and thus the user equipment or the mobile terminal receives no or poor wireless signals.

The mobile terminal mobility refers to that the user equipment or the mobile terminal may be moved with the user. When the user equipment or the mobile terminal moves to edge of the service coverage of the service base station, a handover is needed. But, handover may result signal loss or transmission delay.

Besides, when the user equipment or the mobile terminal moves, intra-sector beam switch and/or inter-sector beam switch may occur. Thus, how to prevent processing latency in intra-sector beam switch and/or inter-sector beam switch is an effort.

### SUMMARY

According to one embodiment, provided is a user equipment (UE) wireless coupled to a plurality of sectors. The UE includes: an antenna array being configured to receive a plurality of wireless signals from a plurality of beams; and a processing unit, coupled to the antenna array, the processing unit being configured to measure a plurality of wireless signal quality of the wireless signals to determine a target wireless signal quality among the plurality of wireless signal quality and the processing unit being configured to select, among the sectors, a beam emitting the target wireless signal quality as a preferred sector beam. The processing unit controls the antenna array to send to a current service sector beam of the beams a preferred sector beam transmission time index and a beam scan sequence ID corresponding to the target wireless signal quality.

According to another embodiment, provided is a network device in a wireless communication system including a plurality of sectors. The network device wireless is coupled to a user equipment (UE). The sectors emit a plurality of beams to the UE. The network device includes: a processing unit; and a communication module, coupled to the processing unit and at least a sector of the sectors. Based on a preferred sector beam transmission time index and a beam scan sequence ID sent from the UE and received by a service sector beam of the beams, the processing unit determines whether the preferred sector beam transmission time index and the beam scan sequence ID from the UE is matched with the service sector beam. When the processing unit determines that the preferred sector beam transmission time index and the beam scan sequence ID from the UE is not matched with the service sector beam, the processing unit determines whether to perform inter-sector beam switch or intra-sector beam switch based on the preferred sector beam transmission time index and the beam scan sequence ID from the UE.

According to yet another embodiment, provided is an operation method for a user equipment (UE) which is wireless coupled to a plurality of sectors. The UE includes an antenna array and a processing unit. The operation method includes: receiving a plurality of wireless signals from a plurality of beams by the antenna array; measuring a plurality of wireless signal quality of the wireless signals by the processing unit; determining a target wireless signal quality among the plurality of wireless signal quality by the processing unit; selecting, among the sectors, a beam emitting the target wireless signal quality as a preferred sector beam by the processing unit; and controlling, by the processing unit, the antenna array to send to a current service sector beam of the beams a preferred sector beam transmission time index and a beam scan sequence ID corresponding to the target wireless signal quality.

According to still another embodiment, provided is an operation method for a network device in a wireless communication system including a plurality of sectors. The network device is wireless coupled to a user equipment (UE). The sectors emit a plurality of beams to the UE. The network device includes a processing unit. The operation method includes: based on a preferred sector beam transmission time index and a beam scan sequence ID sent from the UE and received by a service sector beam of the beams, determining by the processing unit whether the preferred sector beam transmission time index and the beam scan sequence ID from the UE is matched with the service sector beam; and when the processing unit determines that the preferred sector beam transmission time index and the beam scan sequence ID from the UE is not matched with the service sector beam, determining by the processing unit whether to perform inter-sector beam switch or intra-sector beam switch based on the preferred sector beam transmission time index and the beam scan sequence ID from the UE.

### BRIEF DESCRIPTION OF THE DRAWINGS

FIG. 1 shows a system diagram of a wireless communication system according to an embodiment of the application.

FIG. 2A shows that there is single user equipment in the wireless communication system.

FIG. 2B shows that there are a plurality of user equipment in the wireless communication system.

FIG. 3 shows beam switch according to an embodiment of the application.

FIG. 4 shows introduction of beam scan sequence ID (labeled as Seq. ID) into each beam for assisting the inter sector beam switch and/or the intra sector beam switch.

FIG. 5 shows possible beam scan sequence ID ambiguity.

FIG. 6 shows that in the embodiment of the application, the beam may send the BSS to assist the inter sector beam switch and/or the intra sector beam switch.

FIG. 7 shows another example in solving the beam scan sequence ID ambiguity in an embodiment of the application.

FIG. 8A that shows the PBSS and SBSS are transmitted in a localized structure in an embodiment of the application.

FIG. 8B shows the PBSS and SBSS are transmitted in a distributed structure in an embodiment of the application.

FIG. 9 shows a signal quality table according to an embodiment of the application.

FIG. 10 shows the intra-sector beam switch according to an embodiment of the application.

FIG. 11 shows the inter-sector beam switch in an embodiment of the application.

FIG. 12 shows a functional block diagram of the UE according to an embodiment of the application.

FIG. 13 shows a functional block diagram of the network device according to an embodiment of the application.

FIG. 14 shows an operation of an UE according to an embodiment of the application.

FIG. 15 shows an operation diagram of a network device according to an embodiment of the application.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DESCRIPTION OF THE EMBODIMENTS

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

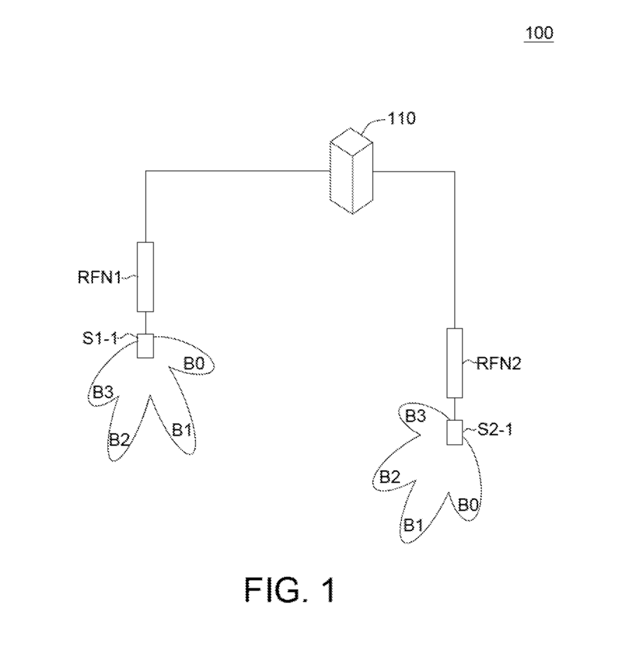

FIG. 1 shows a system diagram of a wireless communication system according to an embodiment of the application. As shown in FIG. 1, the wireless communication system 100 according to the embodiment of the application includes: at least a control device 110 and a plurality of network devices. At least a user equipment (for example but not limited by a smart phone) is wireless coupled to the wireless communication system 100 and is served by one of the sectors of the wireless communication system 100. For simplicity, the network devices are exemplified as Radio Front Node (RFN) RFN1 and RFN2, but the application is not limited by this. For example, the network devices may be main base stations, RFN, new radio (NR) Node B, or eNB (Evolved Node B). Further, the wireless communication system 100 may include more control devices 110 each controlling more network devices. Besides, each network device RFN1 and RFN2 has an antenna array (not shown) which may cover a plurality of sectors. For example, the antenna array of each network device RFN1 and RFN2 may include a plurality of antennas forming three sectors, and each of the sectors covering 120 degrees. Each of the sectors form a plurality of beams, and each beam directs to different directions. For example, in 120 degree, one sector may form 8 beams and each beam directs to different directions. In general, if a sector includes more antennas, then each beam covers a narrower area and the wireless signals from each beam may be transmitted to a far distance. On the contrary, if a sector includes fewer antennas, then each beam covers a wider area and the wireless signals from each beam may be transmitted not so far. Similarly, the user equipment has an antenna array (not shown) forming a plurality of beam each directing to different directions.

For example, each of the network devices RFN1 and RFN2 covers three sectors. But for simplicity, FIG. 1 shows two sectors S1-1 and S2-1, wherein the sector S1-1 belongs to the network device RFN1 (i.e. the network device RFN1 covers the sector S1-1), and the sector S2-1 belongs to the network device RFN2 (i.e. the network device RFN2 covers the sector S2-1). Each of the sectors S1-1 and S2-1 form four beams Bn (n=0-3, n being a natural number and represents beam ID or beam index). Each beam Bn directs to different directions.

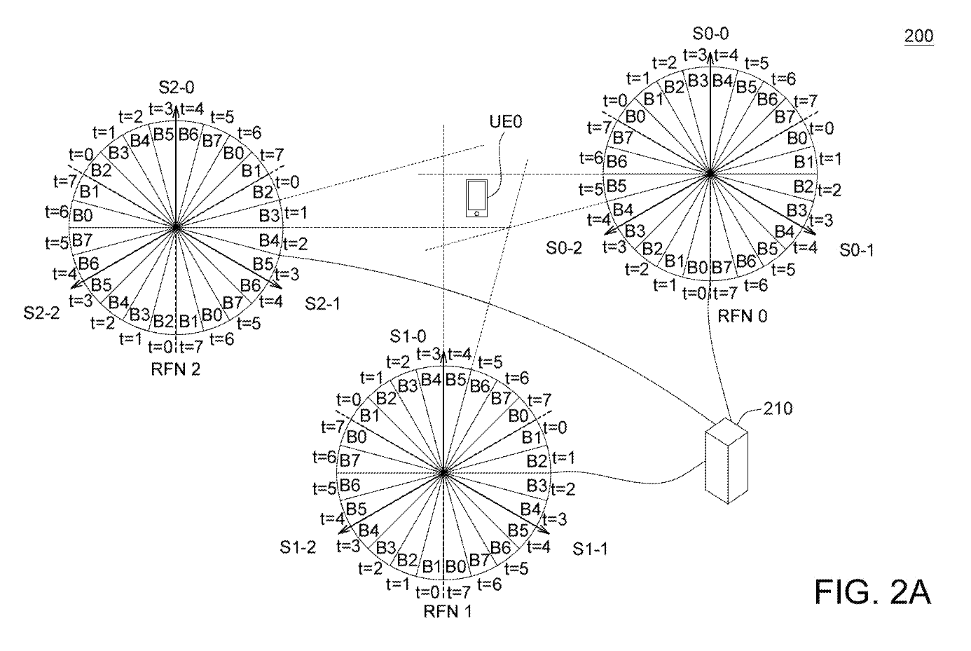

FIG. 2A shows that there is single user equipment in the wireless communication system. FIG. 2B shows that there are a plurality of user equipment in the wireless communication system.

As shown in FIG. 2A and FIG. 2B, in the wireless communication system 200, the control device 210 manages three network devices RFN0-RFN2. The network device RFN0 covers three sectors S0-0 to S0-2, the network device RFN1 covers three sectors S1-0 to S1-2, and the network device RFN2 covers three sectors S2-0 to S2-2. Each of the sectors S0-0 to S2-2 forms 8 beams B0-B7 and each of the sectors covers the same angle (i.e. 120 degrees). The beam configuration parameters of the network devices RFN0-RFN2 are configuration 0-configuration 2, respectively. As for the beam configuration parameter “configuration 0” of the network device RFN0, the 8 beams B0-B7 of the sector S0-0 perform scanning at t=0 to t=7, respectively; and so are the sectors S0-1 and S0-2. As for the beam configuration parameter “configuration 1” of the network device RFN1, the beam B0 of the sector S1-0 performs scanning at t=7, the beam B1 of the sector S1-0 performs scanning at t=0 and so on. As for the beam configuration parameter “configuration 2” of the network device RFN2, the beam B0 of the sector S2-0 performs scanning at t=6, the beam B1 of the sector S2-0 performs scanning at t=7 and so on. The beam configuration parameter refers to different beam scan arrangement.

As for the network device RFN2, at t=0, the sector S2-0 emits the beam B2 for scanning, the sector S2-1 emits the beam B2 for scanning and the sector S2-2 emits the beam B2 for scanning. The network devices RFN0 and RFN1 are similar.

In FIG. 2A, the user equipment UE0 may receive signals from the beam B3 of the sector S2-1 at t=1; the user equipment UE0 may receive signals from the beam B5 of the sector S1-0 at t=4; and the user equipment UE0 may receive signals from the beam B5 of the sector S0-2 at t=5, respectively.

In FIG. 2B, the user equipment UE0 may receive signals from the beam B3 of the sector S2-1 at t=1; the user equipment UE0 may receive signals from the beam B5 of the sector S1-0 at t=4; and the user equipment UE0 may receive signals from the beam B5 of the sector S0-2 at t=5, respectively. Similarly, the user equipment UE1 may receive signals from the beam B3 of the sector S1-0 at t=2; the user equipment UE1 may receive signals from the beam B5 of the sector S2-1 at t=3 and the user equipment UE1 may receive signals from the beam B4 of the sector S0-2 at t=4, respectively.

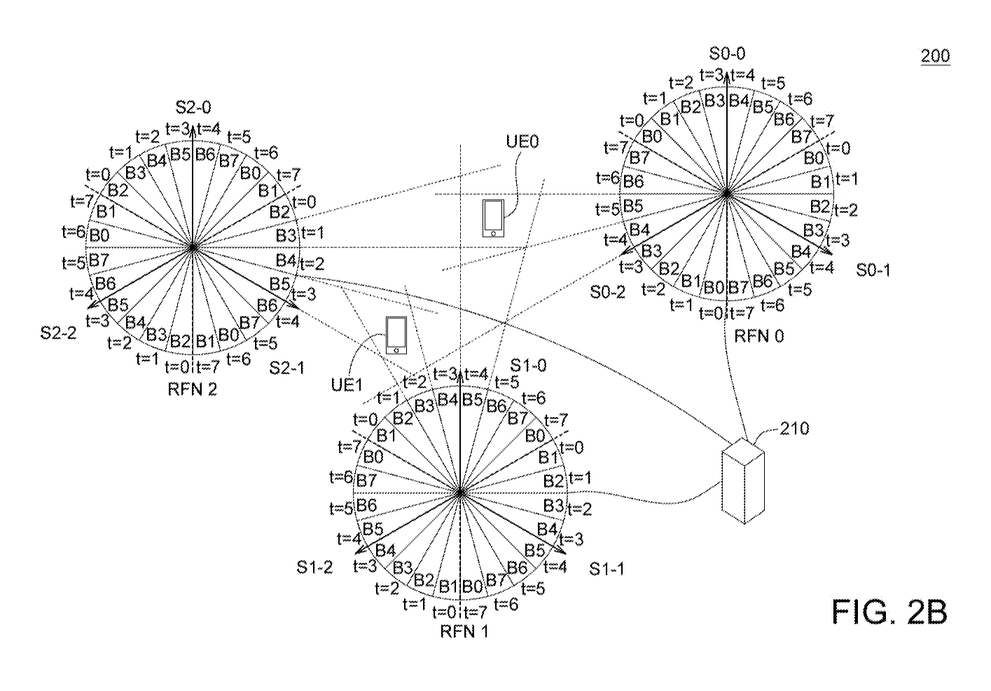

FIG. 3 shows beam switch according to an embodiment of the application. As shown in FIG. 3, at step 310, the network device (RFN) transmits downlink (DL) signals to the user equipment (UE). At step 320, the user equipment (UE) performs beam quality measurement on the received DL signals. At step 330, the user equipment (UE) sends the beam quality measurement result to the network device (RFN). At step 340, the network device (RFN) receives the sector-beam quality measurement result. If the sector-beam quality measurement result indicates that an intra-sector beam switch is required, then the network device (RFN) may perform the intra-sector beam switch. On the other hand, if the sector-beam quality measurement result indicates that an inter-sector beam switch is required, then the network device (RFN) may inform the control device (the control device 110 in FIG. 1) and the control device may perform the inter-sector beam switch. Details of the steps of FIG. 3 will be described later.

Details of the intra-sector beam switch will be described. For example, in FIG. 1, it is assumed that the user equipment is now served by the beam B3 of the sector S1-1. However, based on the sector-beam quality measurement result from the user equipment, the control device and/or the network device judges that the beam B2 of the sector S1-1 is better to the user equipment, that is, the user equipment prefers the beam B2 than the beam B3. However, the user equipment does not know which sector the selected beam B2 belongs to. Based on the signal quality measurement result from the user equipment, the network device (RFN) identifies that the beam B2 selected (preferred) by the user equipment belongs to the sector S1-1. Thus, the network device (RFN) may select the beam B2 of the sector S1-1 to serve the user equipment. That is, “the intra-sector beam switch” refers to that the previous service sector beam (the beam B3 of the sector S1-1) and the next service sector beam (the beam B2 of the sector S1-1) both belong to the same service sector, and the service sector beam switch is performed in the same service sector. Thus, in the embodiment of the application, in order to prevent processing latency, “the intra-sector beam switch” is decided and controlled by the network device (RFN), i.e. “the intra-sector beam switch” is neither decided nor controlled by the control device.

Details of the inter-sector beam switch will be described. For example, in FIG. 1, it is assumed that the user equipment is now served by the beam B3 of the sector S1-1. However, based on the sector-beam quality measurement result from the user equipment, the beam B1 is preferred to the user equipment. However, the user equipment does not know which sector the selected beam B1 belongs to (the selected beam B1 belongs to the sector S2-1). Based on the signal quality measurement result from the user equipment, the network device (RFN) identifies that the service sector beam is switched to the beam B1 of the sector S2-1 to serve the user equipment. Thus, the network device (RFN) may inform the control device 110 and the control device 110 performs the inter-sector beam switch and thus the beam B1 of the sector S2-1 serves the user equipment. That is, “the inter-sector beam switch” refers to that the previous service sector beam (the beam B3 of the sector S1-1) and the next service sector beam (the beam B1 of the sector S2-1) belong to the different sectors, and the service sector beam switch is performed between the different service sectors. Thus, in the embodiment of the application, “the inter-sector beam switch” is decided by the control device, i.e. “the inter-sector beam switch” is not decided by the network device (RFN).

Further, the user equipment has a plurality of beams. The user equipment may select one of the beams as a service user equipment beam to perform signal transmission/reception between the UE and the network device (RFN).

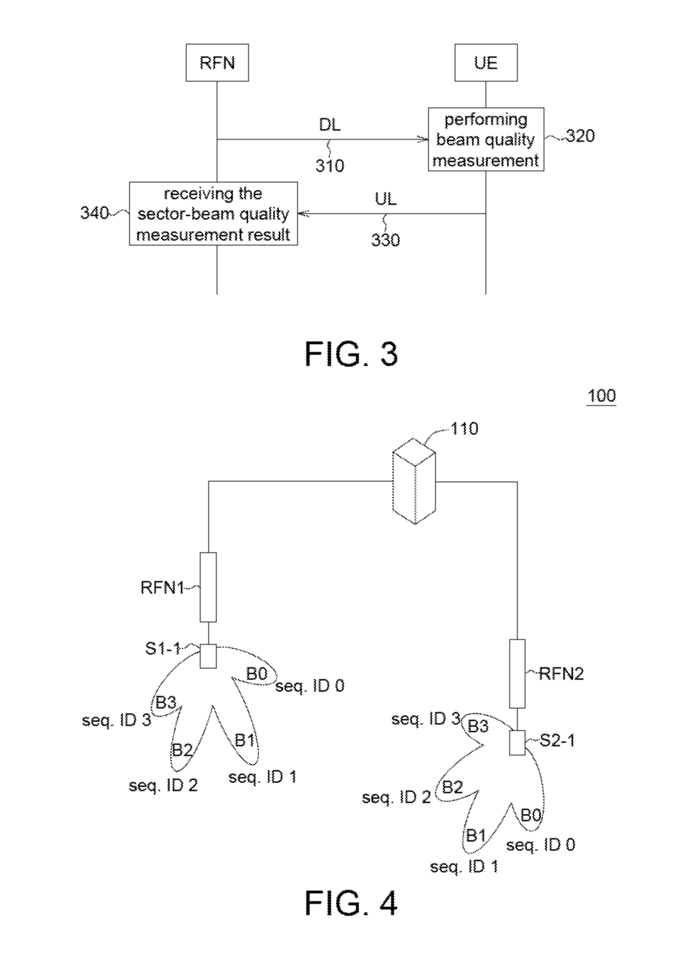

FIG. 4 shows introduction of beam scan sequence ID (labeled as Seq. ID) into each beam for assisting the inter sector beam switch and/or the intra sector beam switch. In the embodiment of the application, the beam scan sequence ID has different definition from the beam ID and the beam index. The beam ID (or beam index) is referred to a ‘logical’ ID of the beam, and the beam scan sequence (BSS) ID is referred to a ‘physical’ ID of the beam. Specifically, the beam scan sequence ID is the scanning sequence of each beam.

As shown in FIG. 4, the beams B0-B3 of the sector S1-1 have the beam scan sequence IDs as Seq.ID0, Seq.ID1, Seq.ID2 and Seq.ID3, respectively; and the beams B0-B3 of the sector S2-1 have the beam scan sequence IDs as Seq.ID0, Seq.ID1, Seq.ID2 and Seq.ID3, respectively. That is, different sectors may have the same set of beam scan sequence IDs but the application is not limited by this.

Assume the wireless communication system uses “J” beam scan sequence IDs (as shown in FIG. 4, four beam scan sequence IDs (i.e. J=4)). “J” may be Q≤J≤(Q*Nd), wherein Q refers to the total beam number of a single sector and Nd refers to the total number of the sectors controlled by the same control device (in FIG. 1, Q=4 and Nd=2).

In beam switch, the user equipment performs J measurement/detection to find the beam for switch. Thus, FIG. 4 (in case of J=Q=4) has the advantage in fast measurement and low signaling overhead.

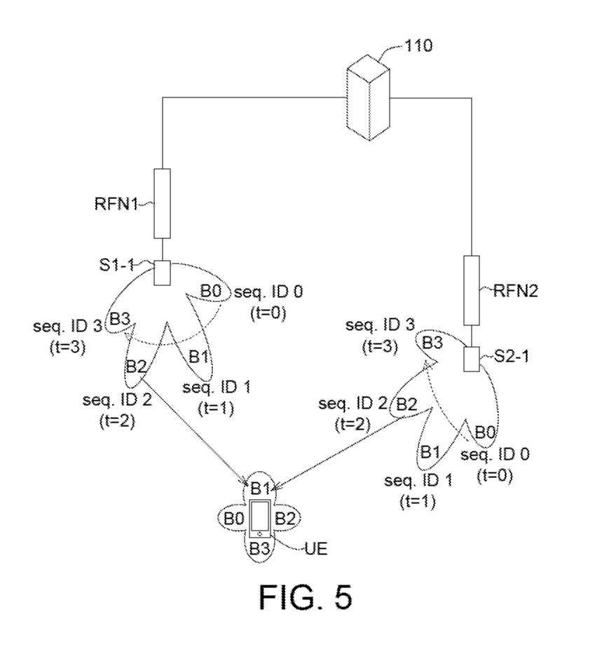

However, if the design of the beam scan sequence ID is not good, then beam scan sequence ID ambiguity may be occurred. FIG. 5 shows possible beam scan sequence ID ambiguity. As shown in FIG. 5, at t=2, the beam B1 of the user equipment UE concurrently receives the signals from the beam B2 of the sector S1-1 (having beam scan sequence ID as Seq. ID2) and the beam B2 of the sector S2-1 (having beam scan sequence ID as Seq. ID2). Thus, the user equipment will have ambiguity. That is, if the user equipment concurrently receives more beams having the same beam scan sequence ID, then the user equipment will have ambiguity.

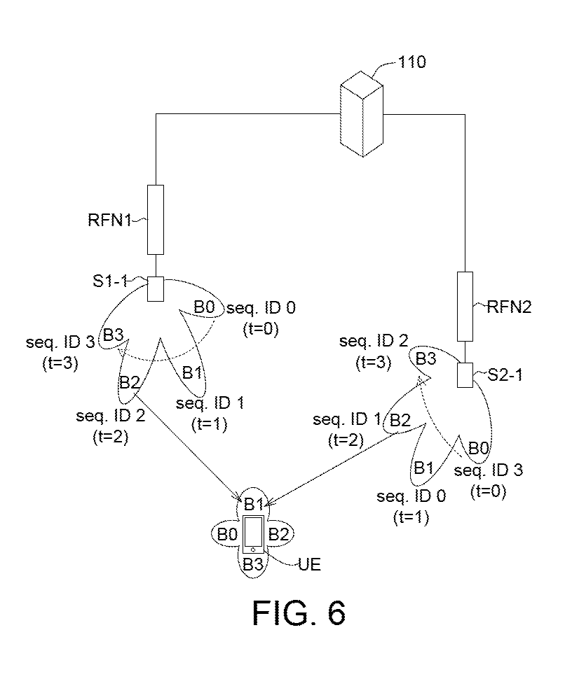

To solve the ambiguity mentioned above, an ‘interlaced’ property is provided in the design of the beam scan sequence (BSS) ID. FIG. 6 shows that in the embodiment of the application, the beams may send the interlaced BSSs to assist the inter sector beam switch and/or the intra sector beam switch.

Table 1 shows possible beam/sector transmission mode.

TABLE 1

| t | t = 0 | t = 1 | t = 2 | t = 3 |
|---|---|---|---|---|
| Sector index | S1-1 (configuration 0) | | | |
| Beam ID | B0 | B1 | B2 | B3 |
| Beam Seq. ID | Seq. ID0 | Seq. ID1 | Seq. ID2 | Seq. ID3 |
| Sector index | S1-2 (configuration 3) | | | |
| Beam ID | B0 | B1 | B2 | B3 |
| Beam Seq. ID | Seq. ID3 | Seq. ID0 | Seq. ID1 | Seq. ID2 |

In Table 1, the beam scan sequence IDs of the beams B0-B3 of the sector S1-1 are Seq.ID0, Seq.ID1, Seq.ID2 and Seq.ID3, respectively; and the beam scan sequence IDs of the beams B0-B3 of the sector S2-1 are Seq.ID3, Seq.ID0, Seq.ID1 and Seq.ID2, respectively. Thus, at t=2, the beam B1 of the user equipment UE receives the signals (having BSS) from the beam B2 of the sector S1-1 (having Seq.ID2) and the beam B2 of the sector S2-1 (having Seq.ID1). The user equipment UE does not suffer from beam scan sequence ID ambiguity because the beams have different beam scan sequence IDs. If the user equipment concurrently receives signals from a plurality of beams (having different beam scan sequence IDs) of different sectors, the user equipment does not suffer from beam scan sequence ID ambiguity.

Table 2 shows a mapping example of the beam scan sequence ID.

TABLE 2

| | | t | | | |
|---|---|---|---|---|---|
| Sector | | t = 0 | t = 1 | t = 2 | t = 3 |
| index | configuration | B0 | B1 | B2 | B3 |
| 0 | Configuration 0 | Seq. ID0 | Seq. ID1 | Seq. ID2 | Seq. ID3 |
| 1 | Configuration 1 | Seq. ID1 | Seq. ID2 | Seq. ID3 | Seq. ID4 |
| 2 | Configuration 2 | Seq. ID2 | Seq. ID3 | Seq. ID4 | Seq. ID5 |
| 3 | Configuration 3 | Seq. ID3 | Seq. ID4 | Seq. ID5 | Seq. ID6 |
| 4 | Configuration 4 | Seq. ID4 | Seq. ID5 | Seq. ID6 | Seq. ID7 |
| 5 | Configuration 5 | Seq. ID5 | Seq. ID6 | Seq. ID7 | Seq. ID0 |
| 6 | Configuration 6 | Seq. ID6 | Seq. ID7 | Seq. ID0 | Seq. ID1 |
| 7 | Configuration 7 | Seq. ID7 | Seq. ID0 | Seq. ID1 | Seq. ID2 |

From Table 2, in case that a control device controls 8 sectors each forming 4 beams, in the same time, at most 8 different beams (having different beam scan sequence IDs) are allowed to send signals (having BSS) to the user equipment. In beam switch, the user equipment does not suffer from the beam scan sequence ID ambiguity.

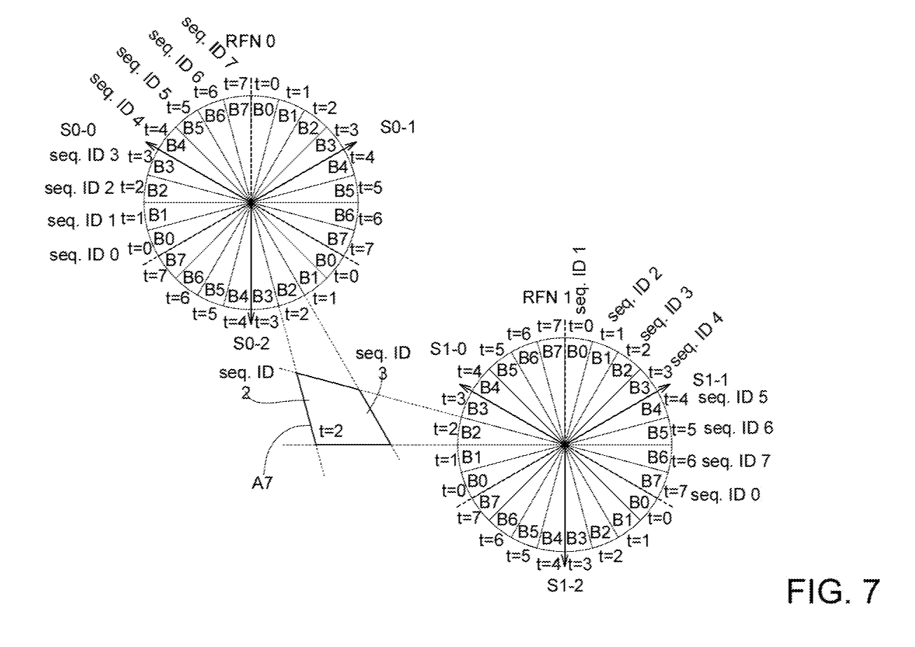

FIG. 7 shows another example in solving the beam scan sequence ID ambiguity in an embodiment of the application. As shown in FIG. 7, at t=2, the user equipment at the area 7A concurrently receives signals from two beams B2 and B2 (having the beam scan sequence ID as Seq. ID2 and Seq. ID3).

The BSS includes PBSS (primary BSS) and SBSS (secondary BSS). In the network entry mode, PBSS may be helpful in fast finding UE service beam, and SBSS may be helpful in finding service sector beam of the service sector. The network entry mode refers to that in initial power on of the user equipment, the user equipment does not yet find the service sector and the service sector beam. In the UE connection mode, the UE may track the UE beam and the sector beam by using PSBB or SBSS. The UE connection mode refers to the UE is already connected to the service sector.

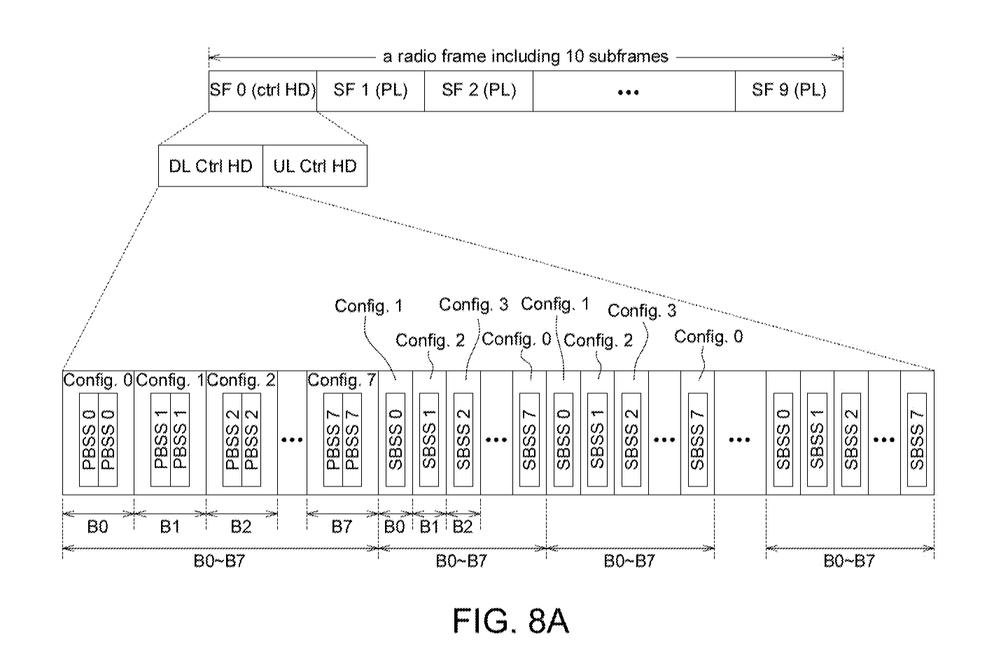

The allocation of PSBB and SBSS in wireless signal transmission will be described. FIG. 8A that shows the PBSS and SBSS are transmitted in a localized structure in an embodiment of the application. FIG. 8B shows the PBSS and SBSS are transmitted in a distributed structure in an embodiment of the application.

In FIG. 8A and FIG. 8B, a radio frame includes 10 subframes SF0-SF9. “ctrl HD” refers to a control header. Assume that the subframe SF0 is used to transmit the control header (of course the application is not limited by this, other subframes may be used to transmit the control header). The control header includes downlink control header (DL Ctrl HD) and uplink control header (UL Ctrl HD), wherein the downlink control header (DL Ctrl HD) is for allocating PBSS and SBSS.

As shown in FIG. 8A, the beam B0 sends 2 PBSS0 signals (repetition) to the user equipment based on “configuration 0” (for example, the beam B0 has the beam scan sequence ID as Seq. ID0). The beam B1 sends 2 PBSS1 signals to the user equipment based on “configuration 1” (for example, the beam B1 has the beam scan sequence ID as Seq. ID1), and so on. After the beams B0-B7 send the PBSS signals, the beam B0 sends one SBSS0 signal to the user equipment based on “configuration 1” (for example, the beam B0 has the beam scan sequence ID as Seq. ID1), the beam B1 sends one SBSS1 signal to the user equipment based on “configuration 2” (for example, the beam B1 has the beam scan sequence ID as Seq. ID2), and so on.

As shown in FIG. 8B, the beam B0 sends 2 PBSS0 signals to the user equipment based on “configuration 0”; the beam B0 sends 4 SBSS0 signals to the user equipment based on “configuration 1”, and so on.

In transmitting PBSS and SBSS, the mapping table of the beam scan sequence ID is shown in Table 3, but the application is not limited by. In table, “Con.” refers to configuration parameter.

TABLE 3

| Sec- | | t = 0 | t = 1 | t = 2 | t = 3 | t = 4 | t = 5 | t = 6 | t = 7 |
|---|---|---|---|---|---|---|---|---|---|
| tor | Con. | B0 | B1 | B2 | B3 | B4 | B5 | B6 | B7 |
| 0 | Con. 0 | Seq. | Seq. | Seq. | Seq. | Seq. | Seq. | Seq. | Seq. |
| | | ID0 | ID1 | ID2 | ID3 | ID4 | ID5 | ID6 | ID7 |
| 1 | Con. 1 | Seq. | Seq. | Seq. | Seq. | Seq. | Seq. | Seq. | Seq. |
| | | ID1 | ID2 | ID3 | ID4 | ID5 | ID6 | ID7 | ID0 |
| 2 | Con. 2 | Seq. | Seq. | Seq. | Seq. | Seq. | Seq. | Seq. | Seq. |
| | | ID2 | ID3 | ID4 | ID5 | ID6 | ID7 | ID0 | ID1 |
| 3 | Con. 3 | Seq. | Seq. | Seq. | Seq. | Seq. | Seq. | Seq. | Seq. |
| | | ID3 | ID4 | ID5 | ID6 | ID7 | ID0 | ID1 | ID2 |
| 4 | Con. 4 | Seq. | Seq. | Seq. | Seq. | Seq. | Seq. | Seq. | Seq. |
| | | ID4 | ID5 | ID6 | ID7 | ID0 | ID1 | ID2 | ID3 |
| 5 | Con. 5 | Seq. | Seq. | Seq. | Seq. | Seq. | Seq. | Seq. | Seq. |
| | | ID5 | ID6 | ID7 | ID0 | ID1 | ID2 | ID3 | ID4 |
| 6 | Con. 6 | Seq. | Seq. | Seq. | Seq. | Seq. | Seq. | Seq. | Seq. |
| | | ID6 | ID7 | ID0 | ID1 | ID2 | ID3 | ID4 | ID5 |
| 7 | Con. 7 | Seq. | Seq. | Seq. | Seq. | Seq. | Seq. | Seq. | Seq. |
| | | ID7 | ID0 | ID1 | ID2 | ID3 | ID4 | ID5 | ID6 |

In the localized structure of FIG. 8A, transmission of PBSS and SBSS is not interleaved, that is, all the beams B0-B7 transmit PBSS first, and then all the beams B0-B7 transmit SBSS. As for the beam B0, in FIG. 8A, in transmitting PBSS and SBSS, the beam B0 applies different beam configuration parameters (for example, in transmitting PBSS, the beam B0 applies configuration 0 while in transmitting SBSS, the beam B0 applies configuration 1).

In the distributed structure of FIG. 8B, transmission of PBSS and SBSS is interleaved, that is, after the beam B0 transmits PBSS and SBSS, then the beam B1 transmits PBSS and SBSS, and so on. As for the beam B0, in FIG. 8B, in transmitting PBSS and SBSS, the beam B0 applies different beam configuration parameters (for example, in transmitting PBSS, the beam B0 applies configuration 0 while in transmitting SBSS, the beam B0 applies configuration 1).

Now, how to perform inter sector beam switch and intra sector beam switch is described. In beam tracking, the user equipment measures the beam signal quality, for example but not limited by, SNR (Signal-to-noise ratio), SIR (Signal to Interference ratio), SINR (Signal to Interference plus Noise Ratio), RSSI (receive signal strength indicator), RSRP (Reference Signal Receiving Power) and RSRQ (Reference Signal Received Quality).

The user equipment may measure the signal quality of any pair of the sector beam and UE beam; and the user equipment may list in a table (or store in the memory of the user equipment). For example, in FIG. 6, at t=2, the user equipment may calculate the BSS signal quality of two beams B2 (having Seq. ID2 and Seq. ID1, respectively) received by the user equipment beam B1 and store into the table.

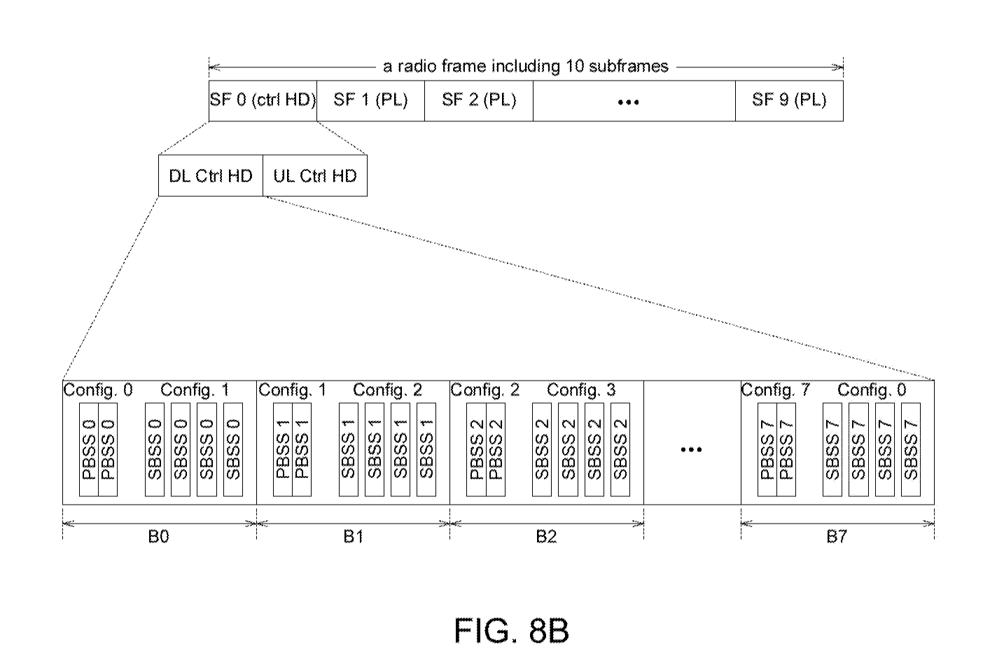

For example, SNR calculated by the user equipment is shown in FIG. 9. FIG. 9 shows a signal quality table according to an embodiment of the application. FIG. 9 shows the case that the user equipment has 4 beams and each sector has 4 beams (having Seq. ID0-Seq. ID3, respectively), but the user equipment does not know which sector the beams received by the user equipment belong to. The application is not limited thereby. In FIG. 9, in the first DL sector scan beam period (t=0), if the sending beam is sector beam 0 (i.e. sector beam ID=0), the user equipment uses respective UE beams B0-B3 to match with sector beam 0 (i.e. sector beam ID=0) to obtain wireless signal quality γ_{0,0}(0), γ_{1,0}(0), γ_{2,0}(0) and γ_{3,0}(0). Then, if the sending beam is sector beam 1 (i.e. sector beam ID=1), the user equipment uses respective UE beams B0-B3 to match with sector beam 1 (i.e. sector beam ID=0) to obtain wireless signal quality γ_{0,1}(0), γ_{1,1}(0), γ_{2,1}(0) and γ_{3,1}(0), and so on. In FIG. 9, γ_{a,b}(t) refers to the wireless signal quality of the pair of the sector beam “b” (b=0-3 in FIG. 9) and the user equipment beam “a” (a=0-3 in FIG. 9) in the DL sector scan beam period “t” (t=0-3 in FIG. 9). Thus, in four DL sector scan beam periods (t=0 to t=3), the user equipment obtains and stores 64 possible wireless signal measurement results γ_{a,b}(t). The processing unit (not shown) of the user equipment may decide a target value (for example but not limited by, a maximum) among the 64 wireless signal measurement results γ_{a,b}(t). Based on the target value, UE may select the UE beam “a” as a preferred UE beam (i.e. UE would like to use this preferred UE beam “a” to receive wireless signals), and select the sector beam “b” as a preferred sector beam (i.e. the UE would like to be served by this sector beam “b”). Here it is assumed that the maximum value among the 64 wireless signal measurement results γ_{a,b}(t) is γ_{2,1}(t). The UE may send back the preferred sector beam transmission time index (t=1) (which is related to the maximum wireless signal quality) and the beam scan sequence ID (Seq. ID1) to the RFN. Further, in sending back, the UE may send all or a subset of the wireless signal quality results measured by the preferred UE beam to the RFN.

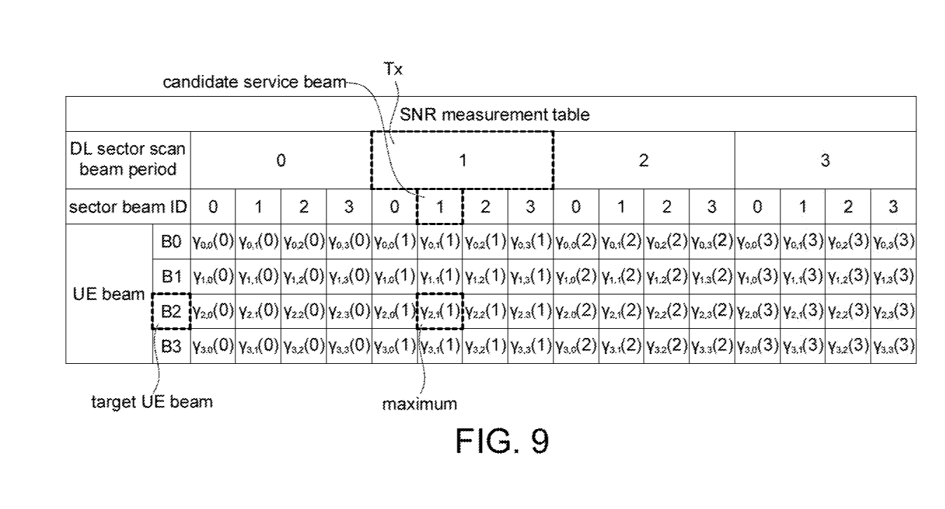

FIG. 10 shows the intra-sector beam switch according to an embodiment of the application. After the UE decides the preferred UE beam and preferred sector beam, the UE sends the preferred sector beam transmission time index t (t=1 in this case), the beam scan sequence ID (Seq. ID1) of the preferred sector beam and/or all or a subset of the wireless signal quality measured by the preferred UE beam to the service sector beam (B2 having Seq. ID2) of the service RFN (RFN 1).

Because the UE may move and/or rotate, in an embodiment of the application, by tracking the beam signals, the UE may switch to the preferred target sector beam and/or the preferred target sector. Switching the service sector beam refers to the intra-sector beam switch, and switching the service sector refers to the inter-sector beam switch.

Now, how to perform intra-sector beam switch according to an embodiment of the application is described. It is assumed that the current service sector is the sector S1-1 and the beam B2 (having Seq. ID2) of the sector S1-1 is the current service sector beam. After the network device RFN1 receives the report information (the preferred sector beam transmission time index t (t=1) and the beam scan sequence ID (Seq. ID1) of the sector beam) from the UE, the network device RFN1 compares with the stored mapping table of the beam scan sequence ID. It is assumed that the sector S1-1 applies “Configuration 0” and the sector S2-1 applies “Configuration 7”. After lookup table, the network device RFN1 identifies that the report information (t=1 and Seq. ID1) is not matched to the current service sector beam (the beam B2 of the sector S1-1, which is matched to t=2 and Seq. ID2). Thus, after lookup table, the network device RFN1 determines that the report information (t=1 and Seq. ID1) is matched to the beam B1 of the sector S1-1 (or said, the report information is not matched to the current service sector beam but matched to the current service sector). The network device RFN1 determines that the intra-sector beam switch is required, and the network device RFN1 switches the current service sector beam from the beam B2 of the sector S1-1 to the target beam B1 of the sector S1-1. Because the intra-sector beam switch is neither done nor controlled by the control device, the processing latency is small.

With report information received from UE, if the network device RFN1 knows that the report information “t=2” and “Seq. ID2” is matched to the current service sector beam (i.e. the beam B2 of the sector S1-1, which is related to “t=2” and “Seq. ID2”), then the current service sector beam does not need to be changed (i.e. the beam B2 of the sector S1-1 is still selected as the current service sector beam).

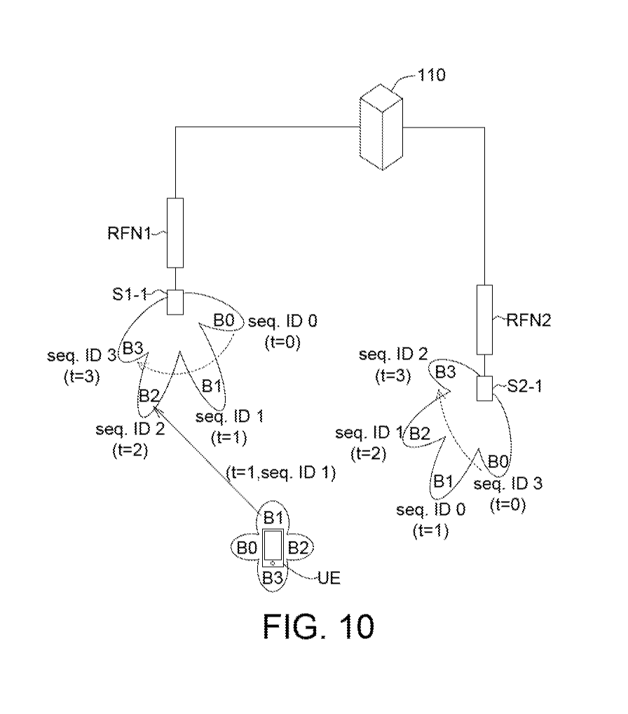

Now, how to perform inter-sector beam switch in an embodiment of the application is described. FIG. 11 shows the inter-sector beam switch in an embodiment of the application. It is assumed that the sector S1-1 is the current service sector and the beam B2 (having Seq. ID2) of the sector S1-1 is the current service sector beam. After wireless signal quality calculation, the UE sends the information “preferred sector beam transmission time index t=2” and “the beam scan sequence ID (Seq. ID1) of the sector beam” to the current service sector beam B2 of the current service sector S1-1 of the network device RFN1. After lookup table, the network device RFN1 determines that the inter-sector beam switch is required because the UE sends the report information “preferred sector beam transmission time index t=2” and “beam scan sequence ID (Seq. ID1) of the sector beam” is not matched to the current service sector beam B2 (having Seq. ID2) of the current service sector S1-1. On the contrary, the report information is matched to another sector S2-1 (i.e. the report information is matched neither the current service sector beam nor the current service sector).

The network device RFN1 sends the report information “preferred sector beam transmission time index t=2” and “the beam scan sequence ID (Seq. ID1) of the sector beam” to the control device 110, as shown in step S1120. When the control device 110 checks the report information “preferred sector beam transmission time index t=2” and “the beam scan sequence ID (Seq. ID1) of the sector beam”, the control device 110 compares with the beam scan sequence ID mapping table. After lookup table, the control device 110 identifies that the report information “preferred sector beam transmission time index t=2” and “Seq. ID1” is not matched to the current service sector beam B2 of the current service sector S1-1 (which is matched to “preferred sector beam transmission time index t=2” and “Seq. ID2”). That is, after lookup table, the control device 110 determines that the report information “preferred sector beam transmission time index t=2” and “Seq. ID1” is matched to the beam B2 of the sector S2-1. Thus, the control device 110 informs the network device RFN1 that the inter-sector beam switch is required (to switch the service sector from S1-1 to S2-1), as shown in step S1140.

In step S1150, in response to an inter-sector beam switch command from the control device 110, the network device RFN1 sends data-to-be-transmitted to the control device 110. In step S1160, the control device 110 informs the network device RFN2 about the inter-sector beam switch command; the network device RFN2 knows that the beam B2 of the sector S2-1 is selected as the target beam and the control device 110 sends data-to-be-transmitted from the network device RFN1 to the network device RFN2. Thus, the network device RFN2 may send data to the UE via the beam B2 of the sector S2-1.

In an embodiment of the application, inter-sector beam switch is performed under control of the same control device 110. The processing latency is also small.

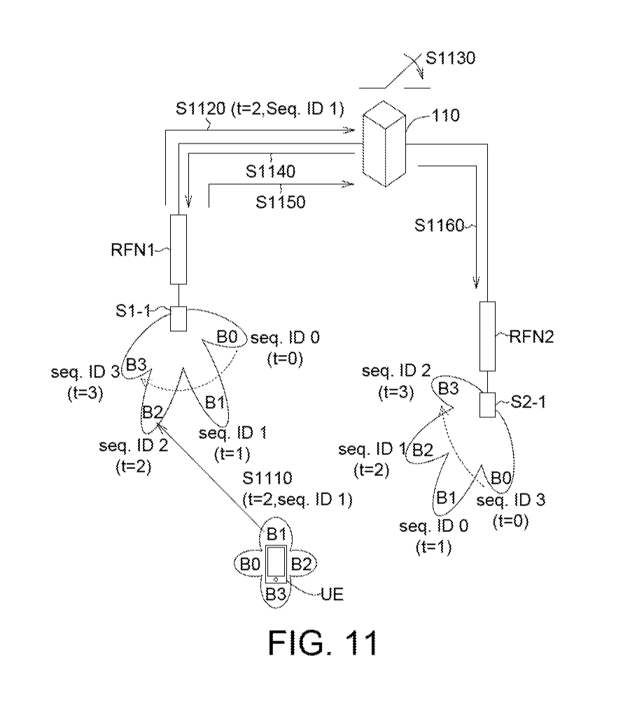

FIG. 12 shows a functional block diagram of the UE according to an embodiment of the application. As shown in FIG. 12, the UE 1200 according to an embodiment of the application includes a processing unit 1210, a memory 1220 and an antenna array 1230. The processing unit 1210 (for example but not limited by, a microprocessor) may measure the wireless signal quality, and select a preferred UE beam and a sector beam. Details of the processing unit 1210 are not repeated here for simplicity. The memory 1220 may store a beam scan sequence ID mapping table and/or wireless quality table (as shown in FIG. 9). The antenna array 1230 may form beams to wireless communicate with the wireless communication system.

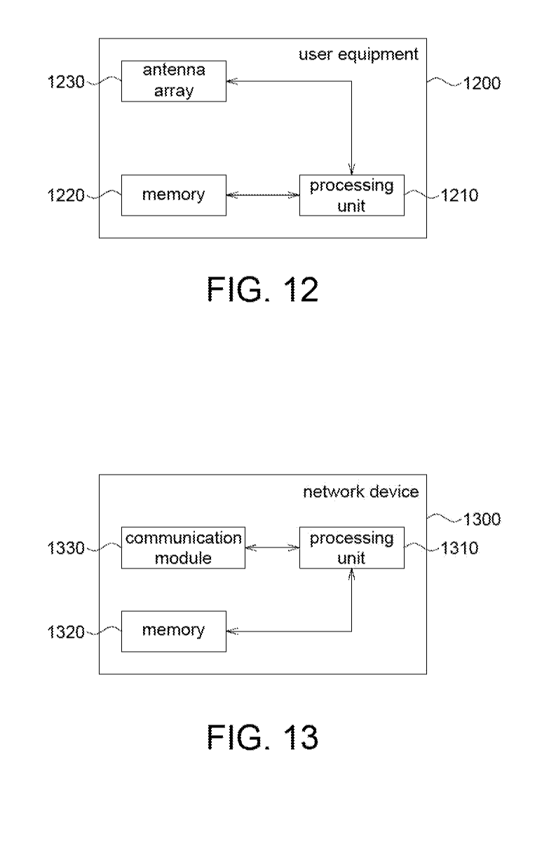

FIG. 13 shows a functional block diagram of the network device (for example RFN) according to an embodiment of the application. As shown in FIG. 13, the network device 1300 includes a processing unit 1310, a memory 1320 and a communication module 1330. The processing unit 1310 (for example but not limited by a microprocessor) is coupled to the memory 1320 and the communication module 1330. The processing unit 1310 may determine whether to perform “intra-sector beam switch” and/or “inter-sector beam switch” based on the report information from the UE. Details of the processing unit 1310 are not repeated here for simplicity. The memory 1320 may store a beam scan sequence ID mapping table and/or wireless quality table. The communication module 1330 may wireless communicate with the control device 110.

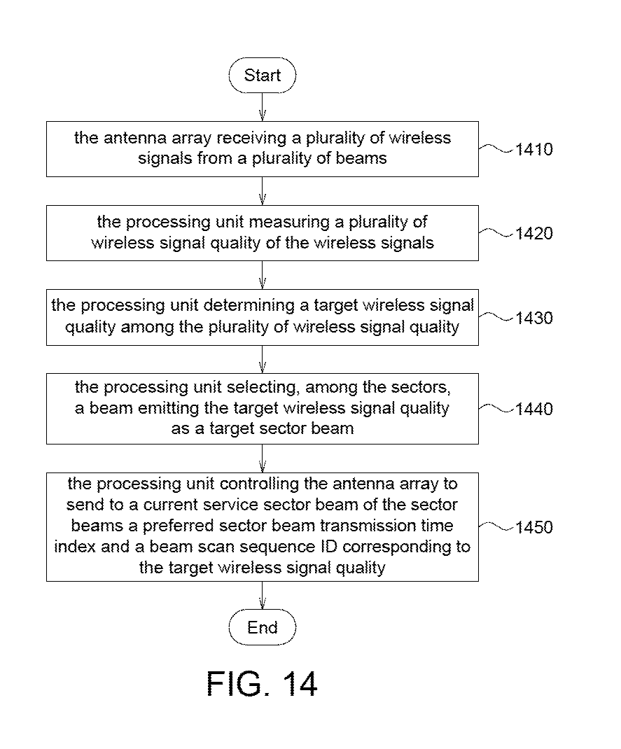

FIG. 14 shows an operation of the UE according to an embodiment of the application. In FIG. 14, at step 1410, the antenna array receives a plurality of wireless signals from a plurality of beams. At step 1420, the processing unit measures a plurality of wireless signal quality of the wireless signals. At step 1430, the processing unit determines a target wireless signal quality (for example, a maximum wireless signal quality) among the plurality of wireless signal quality. At step 1440, the processing unit selects, among the sectors, a beam emitting the target wireless signal quality as a target sector beam. At step 1450, the processing unit controls the antenna array to send to a current service sector beam of the sector beams a preferred sector beam transmission time index and a beam scan sequence ID corresponding to the target wireless signal quality.

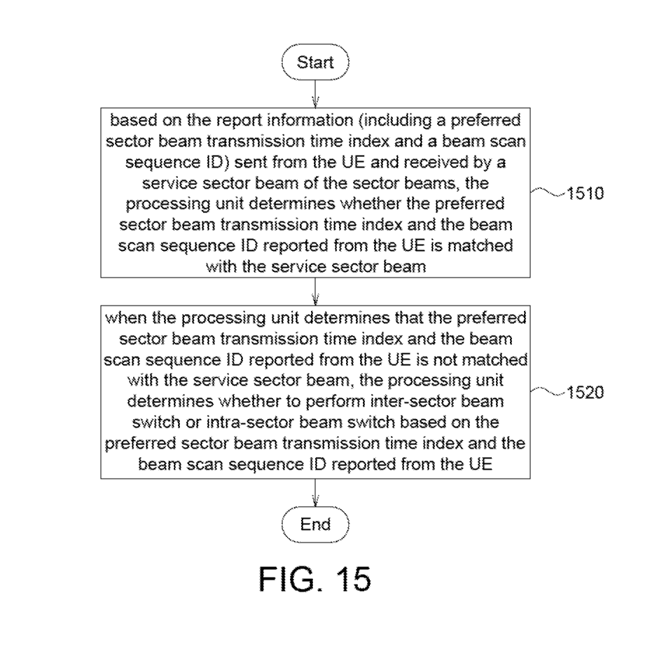

FIG. 15 shows an operation diagram of the network device (RFN) according to an embodiment of the application. In FIG. 15, at step 1510, based on the report information (including a preferred sector beam transmission time index and a beam scan sequence ID) sent from the UE and received by a service sector beam of the sector beams, the processing unit determines whether the preferred sector beam transmission time index and the beam scan sequence ID reported from the UE is matched with the service sector beam. In step 1520, when the processing unit determines that the preferred sector beam transmission time index and the beam scan sequence ID reported from the UE is not matched with the service sector beam, the processing unit determines whether to perform inter-sector beam switch or intra-sector beam switch based on the preferred sector beam transmission time index and the beam scan sequence ID reported from the UE.

As discussed above, in the embodiments of the application, performance of the intra-sector beam switch is not controlled by the control device, and thus, the processing latency is small.

Besides, in performing inter-sector beam switch and/or intra-sector beam switch in the embodiment of the application, the UE measures and returns the wireless signal quality. Thus, the network device does not have to measure the sector quality, and the network device may quickly determine which beam and which sector have the best transmission quality based on the UE report information. Thus, the processing latency of the inter-sector beam switch and/or intra-sector beam switch could be improved.

In summary, the embodiments of the application have the following advantages: low computational complexity, short signal measurement time and low signaling overhead.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A user equipment (UE) wireless coupled to a plurality of sectors, the UE including:
an antenna array being configured to receive a plurality of wireless signals from a plurality of beams; and
a processing unit, coupled to the antenna array, the processing unit being configured to measure a plurality of wireless signal quality of the wireless signals to determine a target wireless signal quality among the plurality of wireless signal quality and the processing unit being configured to select, among the sectors, a beam emitting the target wireless signal quality as a preferred sector beam,
wherein the processing unit controls the antenna array to send to a current service sector beam of the beams a preferred sector beam transmission time index and a beam scan sequence ID corresponding to the target wireless signal quality.

2. The UE according to claim 1, wherein
the antenna array of the UE forms a plurality of UE beams; and
based on the target wireless signal quality, the processing unit selects a preferred UE beam among the plurality of UE beams, and the target wireless signal quality is maximum among the plurality of wireless signal quality.

3. The UE according to claim 2, wherein
the processing unit controls the antenna array to send to the current service sector beam the preferred sector beam transmission time index and the beam scan sequence ID via the selected preferred UE beam.

4. The UE according to claim 2, wherein the processing unit controls the antenna array to send all or a subset of the plurality of wireless signal quality to the preferred sector beam.

5. The UE according to claim 1, further including a memory coupled to the processing unit for storing the measured plurality of wireless signal quality.

6. A network device in a wireless communication system including a plurality of sectors, the network device wireless coupled to a user equipment (UE), the sectors emitting a plurality of beams to the UE, the network device including:
a processing unit; and
a communication module, coupled to the processing unit and at least a sector of the sectors,
wherein based on a preferred sector beam transmission time index and a beam scan sequence ID sent from the UE and received by a service sector beam of the beams, the processing unit determines whether the preferred sector beam transmission time index and the beam scan sequence ID from the UE is matched with the service sector beam; and
when the processing unit determines that the preferred sector beam transmission time index and the beam scan sequence ID from the UE is not matched with the service sector beam, the processing unit determines whether to perform inter-sector beam switch or intra-sector beam switch based on the preferred sector beam transmission time index and the beam scan sequence ID from the UE.

7. The network device according to claim 6, further including a memory coupled to the processing unit for storing a beam scan sequence ID mapping table,
based on the beam scan sequence ID mapping table, the processing unit determines whether the preferred sector beam transmission time index and the beam scan sequence ID from the UE is matched with the service sector beam.

8. The network device according to claim 7, wherein based on the beam scan sequence ID mapping table, when the processing unit determines that the preferred sector beam transmission time index and the beam scan sequence ID from the UE is not matched with the service sector beam but matched with a service sector, based on the preferred sector beam transmission time index and the beam scan sequence ID from the UE, the processing unit decides to perform intra-sector beam switch for selecting another beam of the beams of the service sector of the sectors as the service sector beam.

9. The network device according to claim 8, wherein based on the beam scan sequence ID mapping table, when the processing unit determines that the preferred sector beam transmission time index and the beam scan sequence ID from the UE is matched with neither the service sector beam nor the service sector, the processor unit sends the preferred sector beam transmission time index and the beam scan sequence ID from the UE to a control device of the wireless communication system.

10. The network device according to claim 9, wherein
based on the beam scan sequence ID mapping table and the preferred sector beam transmission time index and the beam scan sequence ID from the UE, the control device decides to perform inter-sector beam switch to select another sector of the sectors as the service sector and to select a beam of the service sector as the service sector beam;
in response to an inter-sector beam switch command from the control device, the network device sends data-to-be-transmitted to the control device; and
the control device sends the data-to-be-transmitted to the service sector for sending to the UE via the service sector beam of the service sector.

11. An operation method for a user equipment (UE) wireless coupled to a plurality of sectors, the UE including an antenna array and a processing unit, the operation method including:
receiving a plurality of wireless signals from a plurality of beams by the antenna array;
measuring a plurality of wireless signal quality of the wireless signals by the processing unit;
determining a target wireless signal quality among the plurality of wireless signal quality by the processing unit;
selecting, among the sectors, a beam emitting the target wireless signal quality as a preferred sector beam by the processing unit; and
controlling, by the processing unit, the antenna array to send to a current service sector beam of the beams a preferred sector beam transmission time index and a beam scan sequence ID corresponding to the target wireless signal quality.

12. The operation method according to claim 11, wherein
the antenna array of the UE forms a plurality of UE beams; and
based on the target wireless signal quality, the processing unit selects a preferred UE beam among the plurality of UE beams, and the target wireless signal quality is maximum among the plurality of wireless signal quality.

13. The operation method according to claim 12, wherein
the processing unit controls the antenna array to send to the current service sector beam the preferred sector beam transmission time index and the beam scan sequence ID via the selected preferred UE beam.

14. The operation method according to claim 12, wherein the processing unit controls the antenna array to send all or a subset of the plurality of wireless signal quality to the preferred sector beam.

15. The operation method according to claim 11, further including a memory coupled to the processing unit for storing the measured plurality of wireless signal quality.

16. An operation method for a network device in a wireless communication system including a plurality of sectors, the network device wireless coupled to a user equipment (UE), the sectors emitting a plurality of beams to the UE, the network device including a processing unit, the operation method including:
based on a preferred sector beam transmission time index and a beam scan sequence ID sent from the UE and received by a service sector beam of the beams, determining by the processing unit whether the preferred sector beam transmission time index and the beam scan sequence ID from the UE is matched with the service sector beam; and
when the processing unit determines that the preferred sector beam transmission time index and the beam scan sequence ID from the UE is not matched with the service sector beam, determining by the processing unit whether to perform inter-sector beam switch or intra-sector beam switch based on the preferred sector beam transmission time index and the beam scan sequence ID from the UE.

17. The operation method according to claim 16, wherein the network device further includes a memory coupled to the processing unit for storing a beam scan sequence ID mapping table,
based on the beam scan sequence ID mapping table, the processing unit determines whether the preferred sector beam transmission time index and the beam scan sequence ID from the UE is matched with the service sector beam.

18. The operation method according to claim 17, wherein based on the beam scan sequence ID mapping table, when the processing unit determines that the preferred sector beam transmission time index and the beam scan sequence ID from the UE is not matched with the service sector beam but matched with a service sector, based on the preferred sector beam transmission time index and the beam scan sequence ID from the UE, the processing unit decides to perform intra-sector beam switch for selecting another beam of the beams of the service sector of the sectors as the service sector beam.

19. The operation method according to claim 18, wherein based on the beam scan sequence ID mapping table, when the processing unit determines that the preferred sector beam transmission time index and the beam scan sequence ID from the UE is matched with neither the service sector beam nor the service sector, the processor unit sends the preferred sector beam transmission time index and the beam scan sequence ID from the UE to a control device of the wireless communication system.

20. The operation method according to claim 19, wherein
based on the beam scan sequence ID mapping table and the preferred sector beam transmission time index and the beam scan sequence ID from the UE, the control device decides to perform inter-sector beam switch to select another sector of the sectors as the service sector and selects a beam of the service sector as the service sector beam;
in response to an inter-sector beam switch command from the control device, the network device sends data-to-be-transmitted to the control device; and
the control device sends the data-to-be-transmitted to the service sector for sending to the UE via the service sector beam of the service sector.
